(19) United States
(12) Patent Application Publication
(10) Pub. No.: US 2025/0346039 A1
(43) Pub. Date: Nov. 13, 2025

(54) INKJET PRINTER INK CARTRIDGE AND INK CARTRIDGE ADAPTER

(71) Applicant: Roland DG Corporation, Hamamatsu-shi (JP)

(72) Inventors: Satoshi HIRAIDE, Hamamatsu-shi (JP); Yuki TOMITA, Hamamatsu-shi (JP)

(21) Appl. No.: 19/276,516

(22) Filed: Jul. 22, 2025

Related U.S. Application Data
(63) Continuation of application No. PCT/JP2023/002110, filed on Jan. 24, 2023.

(51) Int. Cl. B41J 2/175

(52) U.S. Cl. CPC B41J 2/17523; B41J 2/17513; B41J 2/17553; B41J 2002/17516

(57) ABSTRACT

An ink cartridge includes a case main body that includes opposing lateral wall portions and is shaped like a box, of which an upper portion is an open portion, a lid that covers the open portion of the case main body in an attachable/detachable manner, and an adapter that is housed, in an attachable/detachable manner, in an internal space defined by the case main body and the lid, and having attached thereto an ink bag filled with ink. The adapter is housed between the case main body and the lid in a state to be sandwiched by the case main body and the lid.

### CROSS REFERENCE TO RELATED APPLICATIONS

This application is a Continuation Application of PCT Application No. PCT/JP2023/002110 filed on Jan. 24, 2023. The entire contents of this application are hereby incorporated herein by reference.

### BACKGROUND OF THE INVENTION

### 1. Field of the Invention

The present invention relates to inkjet printer ink cartridges and ink cartridge adapters, and in particular, to inkjet printer ink cartridges each housing therein an ink bag filled with ink and to adapters for such ink cartridges.

### 2. Description of the Related Art

Inkjet printers are devices configured to print by reciprocating, in the width direction of recording paper, a recording head that receives a supply of ink from an ink cartridge. Inkjet printers for large-volume printing have a large ink cartridge. It is extremely difficult to install such a large ink cartridge on a carriage accommodating an ink discharge head.

To cope with the circumstances described above, a scheme is adopted by which an ink cartridge is installed on a main body of an inkjet printer in an attachable/detachable manner, and ink is supplied from the ink cartridge to a recording head via a tube. According to a technique disclosed in JP-A-2009-279876, an ink cartridge is provided with a tray structuring a container that houses an ink bag (a pouch) therein, and an adapter attached to the ink bag for holding/fixing the ink bag. When the ink in the ink bag is consumed and used up, the ink bag attached to the adapter is removed from the tray. A new ink bag is mounted on the adapter, which is subsequently fixed to the tray.

Further, according to a technique disclosed in Japanese Patent No. 5586737, an ink cartridge is provided with a case main body which houses an ink bag, while a top portion thereof is open, and a lid (a cover) that closes the open portion of the case main body. When the ink in the ink bag is consumed and used up, the lid of the ink cartridge is opened, so that the used ink bag is taken out and replaced with a new ink bag. The open portion of the case main body is then closed with the lid.

An attachment/detachment structure for the lid of the ink cartridge is configured by providing each of the latch structures on a lateral wall surface of the longer side of the lid and on a lateral wall surface of the longer side of the case main body which opposes the lateral wall surface of the lid in an attachment state. For example, one is provided with a small projection, while the other has a groove formed therein to be latched with the small projection. Further, the shorter side of the lid is provided with a projecting portion, while a position determining hole is formed on the shorter side of the case main body, so that the position is determined in the attachment state, as a result of the projecting portion being latched with the position determining hole.

Further, although not disclosed in the document, another configuration is also known by which an ink bag is attached to an adapter serving as an intermediary member, so that the ink bag in that state is housed in a case main body together with the adapter.

### SUMMARY OF THE INVENTION

In the ink cartridge disclosed in JP-A-2009-279876, because the adapter fixes an ink supply connector (a spout) of the ink bag to the tray, the spout is prevented, to a certain extent, from shifting. However, while the ink cartridge is provided with no lid, the adapter to which the ink bag is attached is simply inserted in an adapter insertion portion without being fixed. Thus, a problem arises where, at the time of attaching or detaching the ink cartridge to or from the inkjet printer, the adapter may easily come off the tray due to an inadvertent collision or fall.

Further, in the opening/closing structure of the ink cartridge disclosed in Japanese Patent No. 5586737, the ink bag is held in the ink cartridge including the case main body and the lid. However, the latch structure of the case main body and the lid uses a relatively simple configuration in order to facilitate the attachment and detachment. Thus, it is necessary to take into consideration the possibility of the spout becoming wobbly or shifting in the event that the latch structure is damaged or has received an impact.

Further, the spout becoming wobbly or shifting as described above may lead to a positional shift relative to an ink suction system of the inkjet printer, which brings about the possibility of hindering an accurate supply of ink. This situation may similarly occur with the configuration in which an ink bag is mounted into a cartridge via an adapter.

Example embodiments of the present invention provide inkjet printer ink cartridges and ink cartridge adapters with each of which it is possible to hold the adapter and an ink bag stably in the ink cartridge.

An ink cartridge according to an example embodiment of the present invention includes a case main body that includes opposing lateral wall portions and is shaped like a box of which an upper portion is an open portion, a lid that covers the open portion of the case main body in an attachable/detachable manner, and an adapter that is housed, in an attachable/detachable manner, in an internal space defined by the case main body and the lid, and having attached thereto an ink bag filled with ink, wherein the adapter is housed between the case main body and the lid, in a state of being sandwiched by the case main body and the lid.

With the above configuration, when the adapter to which the ink bag is attached is housed in a prescribed position within the ink cartridge, so that the lid is attached to cover the case main body, the adapter is sandwiched and held from above and below by the top surface of the adapter and an inner lateral surface of the lid. Accordingly, the force to fix the adapter is enhanced against an external impact and the like on the ink cartridge, so that a spout is prevented from shifting or becoming wobbly.

With an ink cartridge according to an example embodiment of the present invention, the adapter attached to the ink bag is held within the ink cartridge with certainty. Thus, the ink bag is prevented from coming off inadvertently. In addition, the adapter housed in the ink cartridge prevents the spout of the ink bag from shifting. As a result, in the state in which the ink cartridge is installed in the inkjet printer, an excellent connection is achieved between the spout and an ink suction system of the inkjet printer. Consequently, it is possible to improve printing quality of the inkjet printer.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an exploded perspective view showing a state of an ink cartridge according to an example embodiment of the present invention in which a lid has been opened and an adapter provided with an ink bag has been taken out.

FIG. 2 is a schematic configuration drawing showing how to assemble the adapter attached to the ink bag into the ink cartridge according to an example embodiment of the present invention.

FIG. 3A is a schematic configuration drawing showing a manner: in which the adapter is attached to a case main body according to an example embodiment of the present invention.

FIG. 3B is a schematic configuration drawing showing a manner in which the adapter is sandwiched and held by the case main body and the lid according to an example embodiment of the present invention.

FIG. 3C is a partial enlargement view of FIG. 3B.

FIG. 4 is a schematic configuration drawing showing a bottom surface of the adapter according to an example embodiment of the present invention.

FIG. 5 is a schematic configuration drawing showing a front surface portion of the adapter according to an example embodiment of the present invention.

FIG. 6 is a schematic configuration drawing showing a perspective view of the adapter according to an example embodiment of the present invention.

FIG. 7 is a schematic configuration drawing showing how to mount an IC substrate onto the bottom surface of the adapter according to an example embodiment of the present invention.

FIG. 8A is a schematic configuration drawing showing a perspective front view, in the direction of the attachment to the inkjet printer, of the ink cartridge that does not have the adapter housed therein, according to an example embodiment of the present invention.

FIG. 8B is a schematic configuration drawing showing a perspective front view, in the direction of the attachment to the inkjet printer, of a manner in which the case main body houses therein the adapter to which the IC substrate is attached, according to an example embodiment of the present invention.

FIG. 9 is a schematic configuration drawing showing a perspective front view, in the direction of the attachment to the inkjet printer, of the lid of the ink cartridge according to an example embodiment of the present invention.

FIG. 10A is a schematic configuration drawing showing a plan view of the lid of the ink cartridge according to an example embodiment of the present invention.

FIG. 10B is a partial cross-sectional view of FIG. 10A.

### DETAILED DESCRIPTION OF THE EXAMPLE EMBODIMENTS

The following will describe example embodiments of the present invention in detail, with reference to the accompanying drawings.

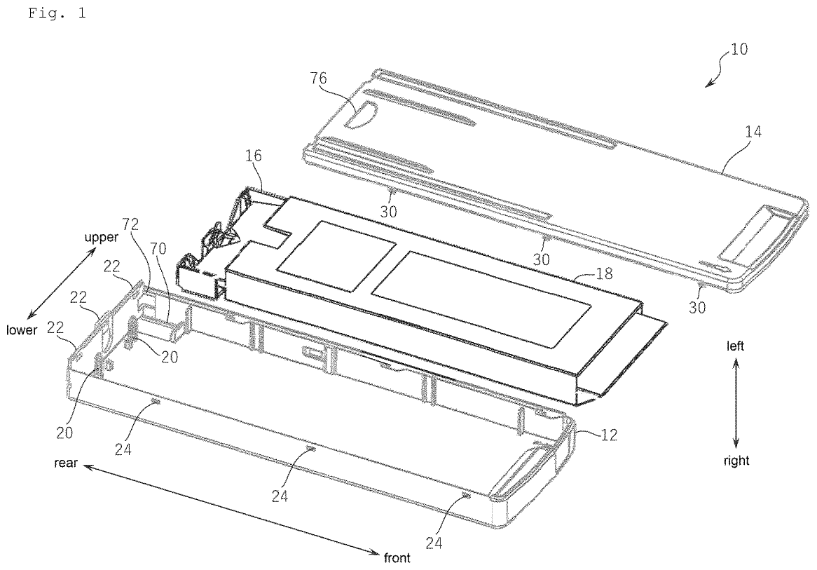

FIG. 1 is an exploded perspective view showing a state of an ink cartridge according to an example embodiment of the present invention in which a cover has been opened and an adapter to which an ink bag (an ink pouch) is attached has been taken out. As shown in the drawing, an ink cartridge 10 includes a case main body 12 shaped like a rectangular box of which one surface is open (the left surface in FIG. 1), and a lid (cover) 14 that is in the shape of an attachable/detachable rectangular substantially rectangular plate to cover the opening of the case main body 12, and is configured so that an adapter 16 to which an ink bag 18 is attached is housed in a space defined by the case main body 12 and the lid 14, together with the ink bag. The directions of the arrows in FIG. 1 will be referred to as a front-rear direction, a left-right direction, and an upper-lower direction.

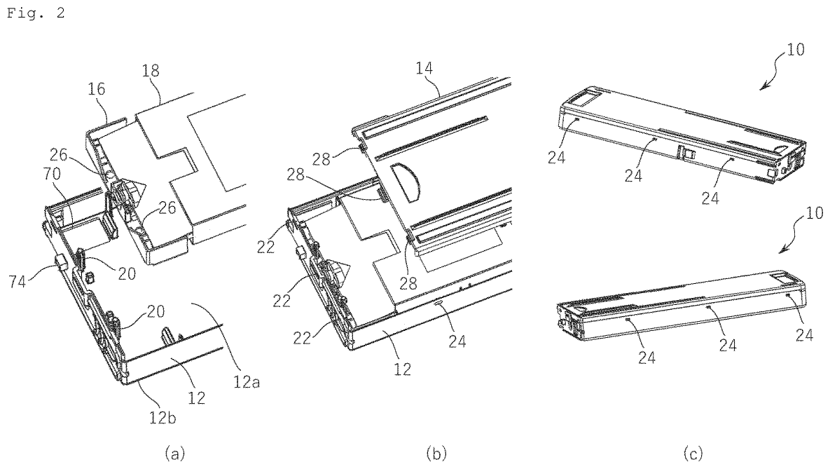

FIG. 2 is a schematic configuration drawing showing how to assemble the adapter attached to the ink bag into the ink cartridge according to an example embodiment of the present invention. The case main body 12 includes two guide pins 20 on a forward lower surface of a bottom portion inner lateral surface 12a. Insertion holes 26 of the adapter 16 to which an ink bag 18 is attached are put though the guide pins 20, so that the adapter 16 is housed in the case main body 12. Further, (for example, three) front engagement claws 28 provided at a front end portion of the lid 14 are inserted in front engagement holes 22 (at three locations) in the case main body 12. Subsequently, lateral engagement claws 30 (for example, three each on the left and the right) provided at lateral end portions of the lid 14 are engaged with lateral engagement holes 24 (for example, three each on the left and the right) in the case main body 12. As a result, the lid 14 is mounted on the case main body 12, while the adapter 16 to which the ink bag 18 is attached is fixed within the ink cartridge 10. In this situation, the attachment of the adapter 16 to the ink bag 18 to be housed in the ink cartridge 10 is realized as a result of an ink supply connector (a spout) 19 provided for the ink bag 18 being fitted into a U-shaped fitted groove 17 at a front center of the adapter.

In the ink cartridge 10 according to an example embodiment of the present invention structured as described above, the adapter 16 is housed in the ink cartridge 10, while the adapter 16 to which the ink bag 18 is attached is sandwiched and held by the case main body 12 and the lid 14. As a result, when being housed in the ink cartridge 10, the adapter 16 is fixed on the inside, and also, the position of the spout 19 of the ink bag attached to the adapter 16 is also determined within the ink cartridge 10.

The ink cartridge 10 according to an example embodiment of the present invention structured as described above is configured so that the adapter 16 is housed in the ink cartridge 10 while being sandwiched and held by the case main body 12 and the lid 14. In this manner, the position of the spout 19 is accurately determined, and the fixation of the adapter 16 itself in the ink cartridge 10 is made more certain. In addition, the position of an IC substrate 60 (explained later) housed in the adapter 16 is also accurately determined. For secure connection with the ink suction system on the inkjet printer side, it is requisite to have the position of the spout 19 determined accurately. Also, for secure contact with a contact point (not shown) on the inkjet printer side, it is indispensable to determine the position of the IC substrate 60 accurately. Consequently, it is an important advantageous effect of an example embodiment of the present invention that the adapter 16 is fixed within the ink cartridge 10.

In order to accurately fix the adapter 16 within the ink cartridge 10, it is also acceptable to use a configuration in which one of the adapter 16, the case main body 12, and the lid 14 is provided with a reaction force causing portion (not shown). In that situation, it is important that, in the state in which the adapter 16 is sandwiched between the case main body 12 and the lid 14, the reaction force causing portion is provided in one or more locations where the adapter 16 is in contact with the case main body 12 or the adapter 16 is in contact with the lid 14.

With the above configuration, the adapter 16 to which the ink bag 18 is attached is sandwiched and held in a state of being pressed more firmly, as compared to a sandwiched state in conventional examples.

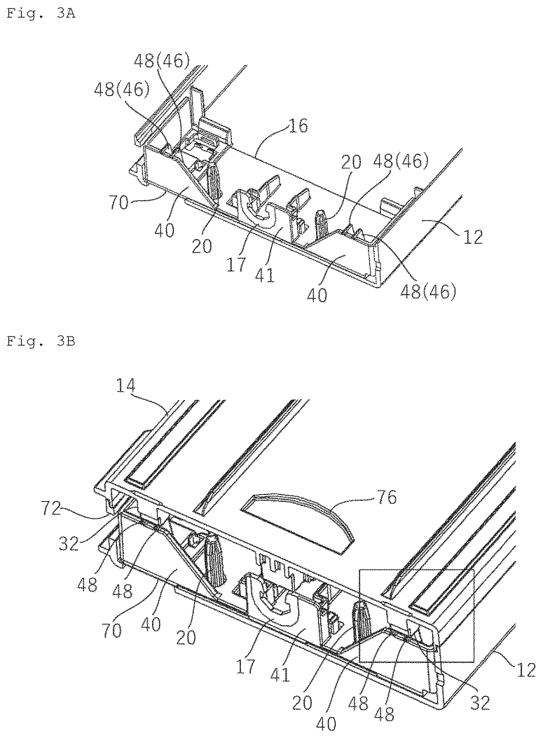

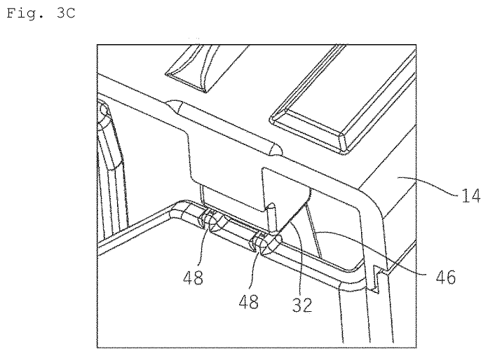

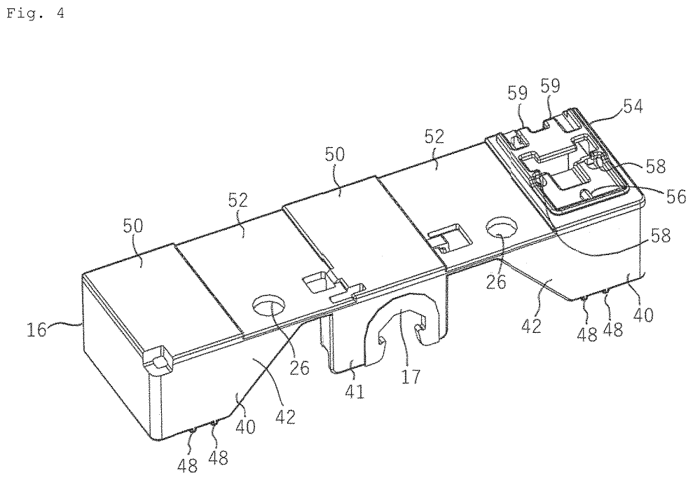

FIG. 3A is a perspective view showing a manner in which the adapter 16 according to an example embodiment of the present invention is housed in the case main body 12. The present drawing is depicted while omitting a case front wall portion 12c so that the interior can be visually recognized. In this situation, projections 48 of the adapter 16 are provided on upper end surfaces of adapter front wall portions 40 in the vicinity of the left and right end portions, so as to provide upwardly-protruding top surfaces of two ribs 46 that reinforce the front wall portions 40 from behind.

FIG. 3B shows a manner in which the adapter 16 of an example embodiment of the present invention is housed in the case main body 12 and is sandwiched and held by the case main body 12 and the lid 14. This drawing is also depicted while omitting the case front wall portion 12c of the case main body 12 so that the interior can be visually recognized. In this situation, when the adapter 16 is sandwiched and held by the case main body 12 and the lid 14, the projections 48 are slightly deformed (i.e., crushed) by local pressing of projecting portions 32 provided on the front of the lid 14 at the left and the right.

FIG. 3C is a partial enlarged view showing a portion of FIG. 3B. The abovementioned projections 48 serve as portions that protrude above the two ribs (reinforcement structures) 46 that reinforce the front wall portions 40 of the adapter 16. In this drawing, it is observed that the projecting portions 32 of the lid 14 are pressing the entire top surfaces of the ribs 46 i.e., the projections 48.

With this configuration, when the adapter 16 to which the ink bag 18 is attached is housed in the ink cartridge 10 and is sandwiched and held by the case main body 12 and the lid 14, the projections 48 provided in upper end portions of the adapter front wall portions 40 in positions opposing the inner lateral surface of the lid 14 are locally pressed by the lid inner lateral surface. As a result, the front wall portions 40 of the adapter serve as portions that cause reaction force against sandwiching and holding force of the lid 14 and the case main body 12. Thus, the fixation state of the adapter 16 within the ink cartridge 10 becomes stable.

The adapter 16 according to an example embodiment of the present invention includes a material that is slightly softer or more plastic, i.e., higher in so-called deformability, as compared to that of the case main body 12 or the lid 14. As a result, when the adapter 16 is sandwiched and held by the case main body 12 and the lid 14, the one or more projections 48 provided in the upper end portions of the adapter front wall portions 40 so as to oppose the inner side of the lid 14 can more easily be deformed (more easily be crushed) as a result of being pressed by the front projecting portions 32 of the lid 14. Consequently, the contact surface area is increased in which the projections 48 in the pressed state are in contact with the front projecting portions 32 formed on the lid 14. Thus, the housed state of the adapter 16 within the ink cartridge 10 becomes even more stable.

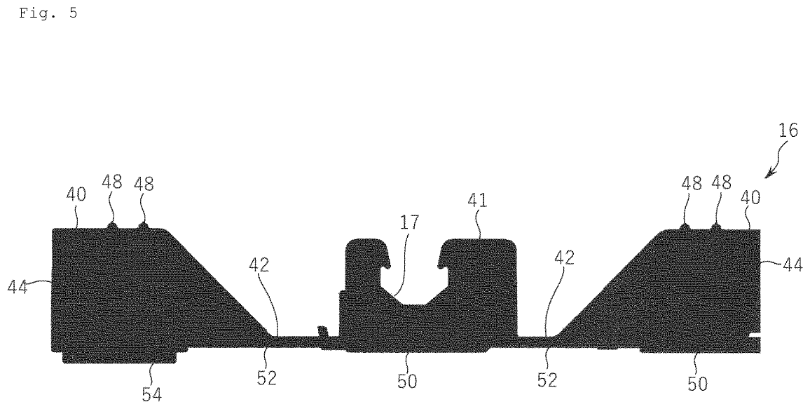

FIG. 4 is a perspective view showing bottom surface portions 50 of the adapter 16 facing upward. As shown in the drawing, the bottom surface portions 50, which are in contact with the bottom portion inner lateral surface 12a of the case main body 12 when the adapter 16 is housed inside the ink cartridge 10, have bottom surface thin portions 52 formed in two locations. In other words, the bottom surface portions 50 of the adapter 16 according to an example embodiment of the present invention have the bottom surface thin portions 52 on either side on the left and the right of the center of the bottom surface portions 50, the bottom surface thin portions 52 each having a rectangular or substantially rectangular shape and to be higher than a reference plane (i.e., so as to be thinner) defined by the height of the bottom surface portions 50 which will be in contact with the bottom portion inner lateral surface 12a of the case main body 12.

With the above configuration, because the bottom surface thin portions 52 are provided in the plurality of locations (two locations in FIG. 4) for the bottom surface portions 50 of the adapter 16, the adapter is more easily bent at the bottom surface thin portions 52 than at other portions. Consequently, even when a defect such as warping or sinking occurs during the manufacture of the adapter 16 realized with injection molding, it is possible to correct the shapes of the bottom surface portions 50 with a deflection deformation of the bottom surface thin portions 52 so as to closely adhere to the bottom portion inner lateral surface 12a of the case main body 12, when the adapter 16 is sandwiched between the case main body 12 and lid 14. As a result, the position determination and the fixation of the adapter 16 in the ink cartridge 10 become stable.

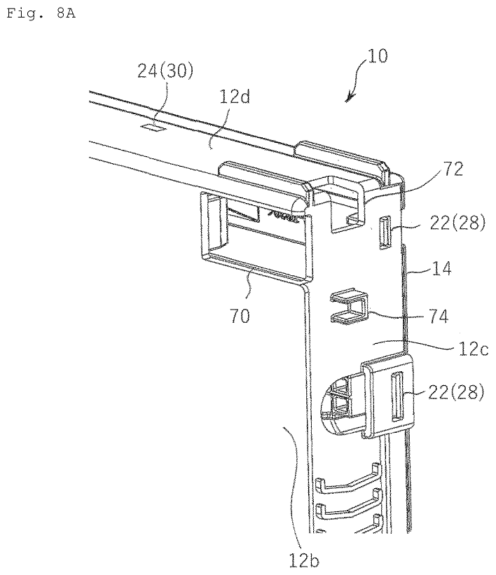

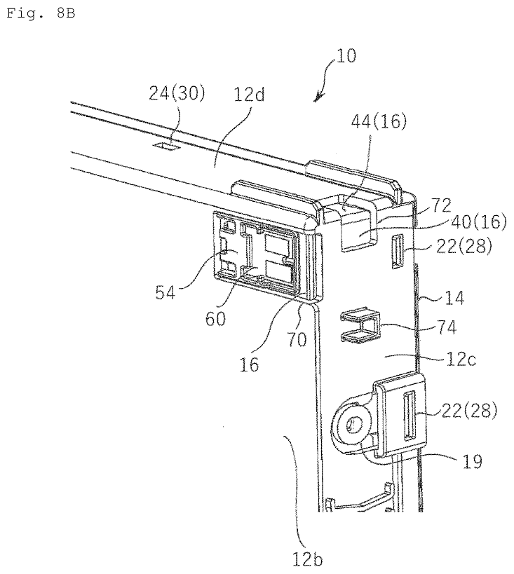

FIG. 5 is a schematic configuration drawing showing a front surface portion of the adapter according to an example embodiment of the present invention. Cutout portions 42 are located on the left and the right of a central portion 41 of the front wall portions 40 of the adapter 16. The cutout portions 42 are deeply incised perpendicularly to a position immediately adjacent to (immediately above) the bottom surface thin portions 52 of the adapter 16, from an upper edge immediately next to the front wall portion central portion 41 provided with the U-shaped fitted groove 17 to which the spout 19 (see FIG. 8B) of the ink bag 18 is designed to be fitted. The cutout portions 42 extend to the left and the right for a certain length along the bottom surface thin portions 52 and subsequently gradually rise at an angle of approximately 45 degrees, so as to end in the vicinity of the placement locations of the projections 48 formed on the upper end faces of the front wall portions 40. Further, as explained above, the projections 48 define a portion of the ribs 46 reinforcing the front wall portions 40 positioned in the vicinity of the left and the right lateral wall portions 44 of the adapter 16. From the rear side, the ribs 46 reinforce the front wall portions 40 of which strength is decreased by the cutout portions 42.

As described above, because the front wall portions 40 of the adapter 16 are provided with the cutout portions 42 which are cut out to the position immediately adjacent to the bottom surface thin portions, it is possible to more easily bend the bottom surface portions at the bottom surface thin portions. Consequently, even when a defect such as warping of the adapter bottom surface portions 50 occurs during the manufacture of the adapter 16 realized with injection molding, it is possible to easily correct the shape of the adapter 16 when the adapter 16 is sandwiched between the case main body 12 and the lid 14, because flexibility is increased in deep locations of the cutout portions 42. This configuration makes excellent position determination and fixation of the adapter 16 in the ink cartridge 10. In addition, by providing the cutout portions 42, it is possible to decrease the material used for the adapter 16, as compared to conventional products.

Further, one of the outer-side bottom surface portions 50 (the bottom surface portion 50 on the left side in the drawing of FIG. 4) positioned on the left and the right on either side of the bottom surface thin portion 52 is provided with an IC substrate housing portion 54 capable of housing therein the IC substrate 60 that is able to store ink information. Further, it is possible to provide the one or more projections 48 (the reaction force causing portions) in the upper end portion of any of the wall portions of the adapter 16. With the above configuration, when the adapter 16 is

installed in the case main body 12, so that the adapter 16 is sandwiched between the case main body 12 and the lid 14, the IC substrate housing portion 54 receives a pressing force from the projections 48 (the reaction force causing portions) so as to be brought into close contact with the bottom portion inner lateral surface 12a of the case main body 12, partially owing to the flexibility of the bottom surface portions 50 realized by providing the cutout portions 42. As a result, because the IC substrate housing portion 54 is accurately fixed within the ink cartridge, it is possible to precisely determine the position of the IC substrate 60 housed in the IC substrate housing portion 54.

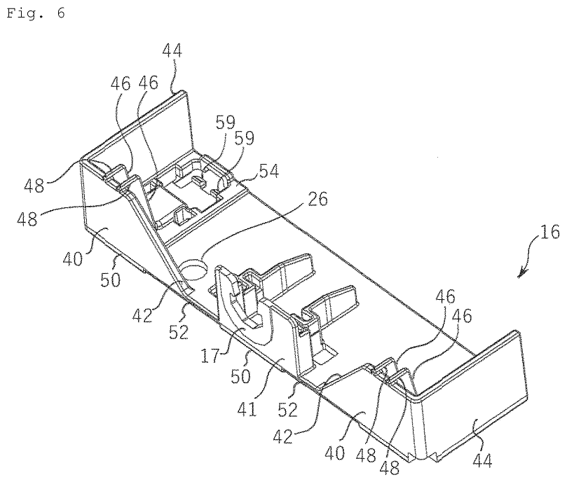

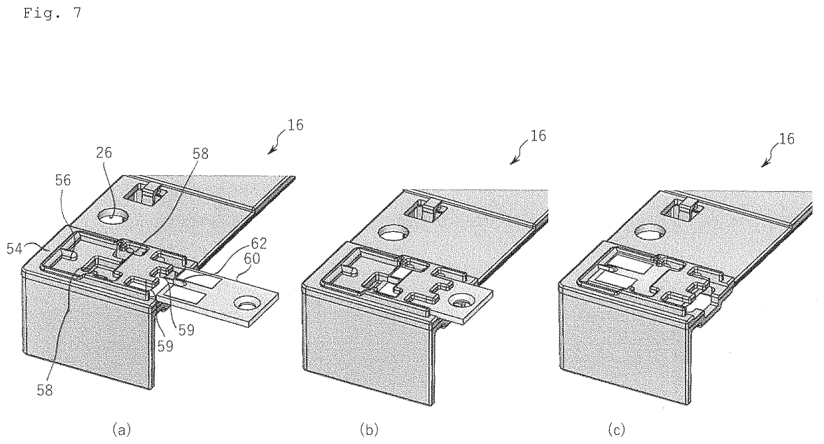

FIG. 6 is a schematic configuration drawing showing a perspective view of the adapter 16 according to an example embodiment of the present invention. As shown in the drawing, observed (see FIG. 4 and FIG. 7 also) in the bottom portion at the left end in the drawing is the rear side of the IC substrate housing portion 54 provided in the bottom surface portion 50 of the adapter 16, i.e., the IC substrate 60, so as to communicate with an opening portion 70 provided in a bottom portion outer lateral wall portion 12b (explained later) of the case main body 12. In other words, the IC substrate housing portion 54 provided in the bottom surface portion 50 of the adapter 16 is capable of housing therein the IC substrate 60 storing the information related to the ink bag 18. The IC substrate housing portion 54 is open at the bottom.

FIG. 7 is a schematic drawing showing a configuration in which the IC substrate 60 is mounted onto the bottom surface portion 50 of the adapter 16 according to an example embodiment of the present invention. The IC substrate housing portion 54 is open toward the top of the drawing. As shown in FIG. 7(a) to FIG. 7(c), the IC substrate 60 is mounted facing the top of the drawing in such a manner that the contact point (not shown) with the inkjet printer is exposed to the outside through the IC substrate housing portion 54.

Provided at the center of an abutted location within the IC substrate housing portion 54 is a straight-on projection 56 used for determining the position of the IC substrate 60 to be inserted. Meanwhile, provided on the IC substrate 60 side is a cutout portion 62 having a shape corresponding to that of the straight-on projection 56. As a result of the straight-on projection 56 and the cutout portion 62 being engaged with each other, the position of the IC substrate 60 is accurately determined within the IC substrate housing portion 54.

Furthermore, sideway projections 58 are provided on the left and on the right in the vicinity of a central portion, in the longitudinal direction, of the IC substrate housing portion 54. Because the sideway projections 58 exert appropriate pressing force in the left and the right directions of the IC substrate 60, within the IC substrate housing portion 54, it is possible to make the fixation of the IC substrate 60 more accurate.

In addition, provided in the vicinity of an insertion opening for the IC substrate 60 in the IC substrate housing portion 54 are two latch claws 59 positioned parallel or substantially parallel to each other while having an interval in the left-right direction. The lower surfaces of the latch claws 59 at tip end portions thereof are sloped so that the thickness increases toward the deeper side of the IC substrate housing portion 54. Sloped portions 59a of the latch claws 59 guide the IC substrate 60 so as to be smoothly housed into the IC substrate housing portion 54. When the IC substrate 60 completes being housed, an upright wall 59b provided behind the sloped portions 59a latches the IC substrate 60. The IC substrate housing portion 54 is structured by using the material of the adapter 16, i.e., the material having flexibility, while being shaped to have flexibility. Thus, with the latch claws 59, it is possible to have the IC substrate 60 latched simply and securely in the manner of a snap-fit (fitting claws).

With the above configuration, the position of the adapter 16 housed in the ink cartridge 10 is accurately determined within the ink cartridge 10. Thus, even though the IC substrate 60 is attached to the adapter 16 unlike the conventional example of being attached to the case main body 12, it is possible to make connection to the contact point of the inkjet printer, without causing a positional shift of the IC substrate.

An ink cartridge according to an example embodiment of the present invention enables distribution in the market in the state in which the ink bag 18 is attached to the adapter 16 to form an integral body, while the IC substrate 60 having recorded the information about the ink bag 18 is also mounted on the adapter 16 and enables collection (recycling) while the used ink bag 18 remains attached to the adapter 16. In other words, unlike conventional examples in which the whole ink cartridge is collected, it is possible to collect only the ink bag (and the adapter) being the contents of the ink cartridge. Consequently, the IC substrate can be mounted on the adapter, instead of being mounted on the ink cartridge itself as in conventional examples. It is therefore convenient because it is possible to distribute and collect the adapter-attached ink bag, while preventing discord between the IC substrate and the ink bag.

FIG. 8A is a schematic drawing showing a perspective front view, in the direction of the attachment to the inkjet printer (not shown), of the ink cartridge 10 that does not have the adapter 16 housed therein, according to an example embodiment of the present invention. The bottom portion outer lateral wall portion 12b of the case main body 12 is depicted closer to the viewer in the drawing, whereas the lid 14 is depicted farther from the viewer in the drawing. In the present drawing, because the ink cartridge 10 does not have the adapter 16 housed therein, the interior of the ink cartridge 10 is visible through the opening portion 70 provided in the bottom portion outer lateral wall portion 12b of the case main body 12.

As observed from FIG. 8A, the opening portion 70 is open so as to straddle two wall portions, namely, the case front wall portion 12c of the case main body 12, i.e., the front surface in the installation direction into the inkjet printer (not shown), and the bottom portion outer lateral wall portion 12b of the case main body 12, i.e., the surface positioned on the left side as viewed from the inkjet printer (not shown). The opening portion 70 exposes the IC substrate housing portion 54 in the bottom surface portion 50 of the adapter 16 and the IC substrate 60. With this configuration, when the ink cartridge 10 is installed in the inkjet printer, it is possible to more accurately bring the IC substrate 60 into contact with the contact point on the inkjet printer side (see FIG. 8B), the IC substrate 60 being attached to the adapter 16 which is housed in the ink cartridge 10 while the position thereof is determined.

Further, the ink cartridge 10 according to an example embodiment of the present invention includes therein a window portion 72 so as to straddle two wall portions, namely, the front wall portion 12c of the case main body 12, i.e., the front surface in the installation direction into the inkjet printer (not shown), and a case lateral wall portion 12d (the top surface in the drawing) of the case main body 12. In this situation, the window portion 72 is slightly shifted to the left in the drawing, relative to the center of the case main body front surface in the width direction.

While the ink cartridge 10 has the adapter 16 housed therein, the window portion 72 is configured to be closed by a corner portion structed by the front wall portion 40 and the lateral wall portion 44 of the adapter 16 (see FIG. 8B). At a location corresponding to the window portion 72, the inkjet printer (not shown) includes a sensor (not shown) that senses the presence/absence of the ink bag 18 in the ink cartridge 10, i.e., the adapter 16 to which the ink bag is attached. The sensor determines whether or not the adapter 16 is housed in the ink cartridge 10, via the adapter 16 exposed through the window portion 72. With the above configuration, if an ink cartridge 10 is installed into the inkjet printer by mistake, without housing therein the adapter 16, i.e., the ink bag 18, the sensor of the inkjet printer senses the absence of the adapter 16 in the ink cartridge 10, i.e., that the ink bag 18 is not housed. Thus, the ink suction system of the inkjet printer is prevented from attempting ink suction in vain. Consequently, it is possible to prevent breakdowns of the inkjet printer.

Further, as described above, the window portion 72 is configured so that, while the ink cartridge 10 has the adapter 16 housed therein, the corner portion structed by the front wall portion 40 and the lateral wall portion 44 of the adapter 16 is exposed. The corner portion of the adapter 16 exposed through the window portion 72 acts as an abutting wall for a cartridge holder in the inkjet printer (not shown). Because the abutting wall is present when the corner portion of the adapter 16 is exposed through the window portion 72, the ink cartridge 10 is prevented from being inserted farther (an excessive insertion) than an appropriate position within the cartridge holder of the inkjet printer. It is therefore possible to prevent the internal structure of the inkjet printer from being damaged.

As shown in the drawings, the window portion 72 straddles the two wall portions, namely, the case front wall portion 12c and the case lateral wall portion 12d (the top face in the drawing). Accordingly, it is possible to sense whether or not the adapter 16 is housed in the ink cartridge 10, i.e., the presence/absence of the ink bag 18, in a wide range from the front and from above. Further, the action of the abutting wall realized by the adapter exposed through the window portion 72 is also made more accurate.

Further, in a position that is slightly lower than the opening portion 70 in the direction immediately below the window portion 72 in the case front wall portion 12c of the case main body 12, the ink cartridge 10 according to an example embodiment of the present invention is provided with a protruding portion 74 with a U-shape to prevent an excessive insertion.

With this configuration, when the adapter 16 is not housed in the ink cartridge 10, because the adapter 16 is not exposed through the window portion 72, no abutting wall is present in the inkjet printer. In that situation, in the event that an ink cartridge 10 having no adapter 16 is installed in the inkjet printer, there is a possibility that the ink cartridge 10 might excessively be inserted in the inkjet printer and that the internal structure of the inkjet printer might be damaged. The excessive insertion protruding portion 74 functions as a stopper to prevent such an excessive insertion of the ink cartridge 10 and is thus able to protect the inkjet printer from being damaged.

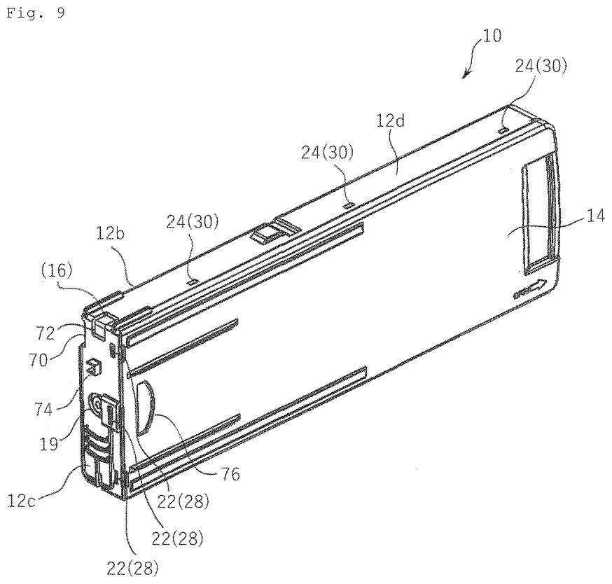

FIG. 9 is a schematic drawing showing a perspective front view, in the direction of the attachment to the inkjet printer, of the lid 14 of the ink cartridge 10 according to an example embodiment of the present invention. The right surface in the drawing represents the lid 14. The left surface in the drawing represents the case front wall portion 12c of the case main body 12. The top surface in the drawing represents the case lateral wall portion 12d that is positioned on the left side of the case main body 12 and observed as the top surface at the time of attachment to the inkjet printer (not shown). The surface corresponding to the rear surface in the drawing represents the bottom portion outer lateral wall portion 12b of the case main body 12.

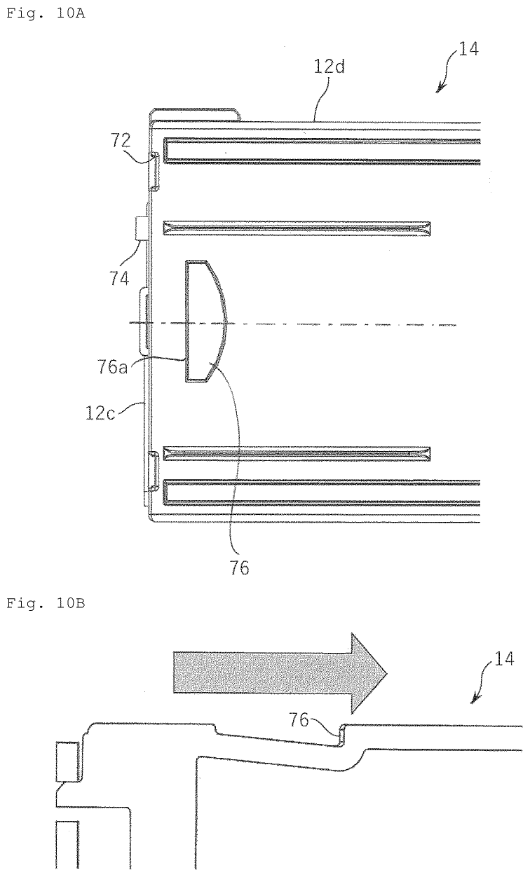

FIG. 10A is a schematic plan view of the lid 14 of the ink cartridge 10 according to an example embodiment of the present invention. Depicted at the top of the drawing is the case lateral wall portion 12d positioned at the top of the ink cartridge 10. Depicted on the left in the drawing is the case front wall portion 12c serving as the front surface in the direction of the attachment to the inkjet printer (not shown). In the lid 14 shown in the drawing, a recessed portion 76 for hooking a finger thereon is positioned substantially at the center in the height direction, on the front surface side of the ink cartridge 10 and is shaped so that a left edge portion forms a longer side 76a, up-and-down edges form shorter sides 76b, and a right edge portion defines a substantially arc portion 76c. Further, FIG. 10B is an enlarged cross-sectional view of the recessed portion 76 in FIG. 10A.

In the state in which the adapter 16 provided with the ink bag 18 is housed inside the case main body 12, the lid 14 is configured to cause the corresponding engagement claws 28 and 30 to be respectively engaged with the front engagement holes 22 and the lateral engagement holes 24 in the case main body 12 while crushing the projections 48 (the top surfaces of the ribs 46) of the adapter 16. In this configuration, the lid 14 is receiving a repulsive force from the projections 48 of the adapter 16. The repulsive force imposes loads on engagement portions between the engagement claws 28 and 30 on the lid 14 and the engagement holes 22 and 24 in the case main body 12, and thus generates strong static friction force. As a result, opening and closing the lid 14 requires a force.

To cope with the above circumstances, a wide recessed portion 76 for hooking a finger thereon is provided on the surface in the vicinity of the front of the lid 14, for the purpose of making it easy to remove the lid 14 from the ink cartridge 10 assembled with the case main body 12 and the lid 14 and housing the adapter 16 therein and facilitating the replacement of the adapter 16 and the ink bag 18 being housed. As shown in FIG. 10B, the recessed portion 76 has a slope so that the bottom surface becomes lower (deeper), starting from the longer side 76a at the front, toward the substantially arc portion 76c on which a finger can be hooked. With this configuration, a worker is able to recognize, at a glance, that the action of opening the lid is made possible by hooking his/her finger on the recessed portion 76. Further, because the substantially arc portion 76c being the right edge positioned at the center, in the width direction, of the lid 14 is structured so that a finger can easily be hooked thereon, it is possible to easily apply the force for the action (sliding action) of opening the lid 14. It is therefore possible to prevent force from being applied unevenly to the locations (28, 30, 22, and 24) where the lid 14 is engaged with the case main body 12 and to thus avoid damaging the ink cartridge 10.

Example embodiments of the present invention have thus been explained in detail together with the drawings. However, applications of the present invention is not limited to the example embodiments described above. It is possible to apply various modifications within the scope of technical ideas set forth in the claims as well as the description and the drawings.

For example, although the lid is provided with the engagement claws while the case main body is provided with the engagement holes in the present example embodiment, it is also acceptable to provide the lid with the engagement holes, while providing the case main body with the engagement claws. Further, as for the relationship of being on the inner side and the outer side between the main body lateral wall portion and the lid lateral wall portion, either one of the two can be on the inner side or the outer side. Further, the shape is not limited to a rectangle as long as opposing lateral wall portions substantially parallel to each other are provided, while the case main body and the lid are slidable relative to each other.

Further, although the one or more projections are provided in the upper end portion of the front wall portion of the adapter in the present example embodiment, another configuration is also possible in which similar projections are provided on the lid side, i.e., in a front portion of the lid, so that the position of the adapter is determined/fixed in the ink cartridge, as a result of being pressed by the projections provided on the lid.

Further, although the adapter includes the material softer than that of the case main body and the lid of the ink cartridge in the present example embodiment, it is also acceptable to form, by using a soft material, only the one or more projections provided on the adapter or only the front wall portion of the adapter. Furthermore, it is also acceptable to facilitate deformation by forming only the front projecting portions on the lid while using a soft material.

Further, in the present example embodiment, the projections provided in the adapter front surface portion on the side that is in contact with the lid may be a portion of the ribs reinforcing the adapter front wall portion. However, it is also acceptable to simply provide projections in an upper end portion of the adapter front wall portion, without providing the ribs.

Furthermore, in the present example embodiment, the cutout portions in the adapter front surface preferably have a substantially V-shape that has the sloped faces. However, as long as the bottom portion of the cutout portion extends to a position immediately above the thin portion of the adapter, so as to guarantee flexibility of the adapter bottom portion, the cutout portion may have a U-shape, for example, and possible cutout shapes are not necessarily limited to the shape described above.

In addition, in the present example embodiment, the U-shaped protruding portion to prevent an excessive insertion is provided in the case main body front surface portion of the ink cartridge. However, the shape of the protruding portion is not limited to a U-shape and may be a rectangular shape, an H-shape, a circular cylindrical shape, or the like. Further, instead of providing a single projection, a plurality of small projection may closely be put together. Further, the shape does not necessarily need to have a space in the central portion thereof like a U-shape. It is acceptable to use any shape such as a circular column, a polygonal column, a polyhedron, or a semicircular column, for example.

Further, in the present example embodiment, the shape of the recessed portion on the lid surface is configured for the action of sliding and opening the lid. However, as long as it is possible to hook one or more fingers thereon, the quantity of the recessed portion does not need to be one, and possible shapes are not limited to the shape described above. For example, instead of providing a single recessed portion, it is acceptable to form one or more bar-shaped groove portions having a depth that allows a finger to hook thereon and extending in the lid width direction, so that the groove portions are arrayed in a substantially triangular formation of which the apex corresponds to the opening direction of the lid. Alternatively, it is also acceptable to provide one or more rectangular-column projections (projecting portions) having a height that allows a finger to hook thereon and extending in the lid width direction.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An ink cartridge comprising:
a case main body that includes opposing lateral wall portions and is shaped like a box, of which an upper portion is an open portion;
a lid that covers the open portion of the case main body in an attachable/detachable manner; and
an adapter that is housed, in an attachable/detachable manner, in an internal space defined by the case main body and the lid, and having attached thereto an ink bag filled with ink; wherein
the adapter is housed between the case main body and the lid in a state of being sandwiched by the case main body and the lid.

2. The ink cartridge according to claim 1, wherein
one of the case main body, the lid, and the adapter is provided with a reaction force causing portion configured to cause a reaction force against a sandwiching direction on the case main body and the lid in the state in which the adapter is sandwiched by the lid and the case main body; and
the reaction force causing portion is provided in at least one location in a portion where, in the state in which the adapter is sandwiched by the lid and the case main body, the adapter is in mutual contact with either the lid or the case main body.

3. The ink cartridge according to claim 2, wherein the reaction force causing portion includes one or more projections that protrude toward an inner lateral surface side of the lid, in a position that is in an upper end portion of a wall portion of the adapter and is sandwiched by the lid and the case main body when the lid is attached to the case main body.

4. The ink cartridge according to claim 2, wherein the adapter includes a material having higher deformability by pressure than materials of the case main body and the lid.

5. The ink cartridge according to claim 1, wherein
the adapter includes a bottom surface portion that is placed on a bottom portion inner lateral surface of the case main body when the adapter is housed in the ink cartridge; and
the bottom surface portion is provided with a bottom surface thin portion that is thinned.

6. The ink cartridge according to claim 5, wherein
the adapter includes at least one cutout portion in a front wall portion; and
the at least one cutout portion is cut out from an upper edge of the front wall portion to a position immediately adjacent to the bottom surface thin portion of the bottom surface portion.

7. The ink cartridge according to claim 6, wherein
the adapter includes the bottom surface portions in two locations on either side of the bottom surface thin portion, the bottom surface portions each being in contact with the bottom portion inner lateral surface of the case main body;
one of the bottom surface portions is provided with an IC substrate housing portion capable of housing therein an IC substrate used to store ink information; and
the reaction force causing portion is provided in an upper end portion of a wall portion rising from the one of the bottom surface portions provided with the IC substrate.

8. The ink cartridge according to claim 7, wherein
the case main body includes an opening portion on a forward side, in an installation direction into an inkjet printer, of a bottom portion outer lateral wall portion;
the adapter includes the IC substrate housing portion to house therein the IC substrate used to store the ink information, in a position that opposes the opening portion when the adapter is housed in the ink cartridge; and
the IC substrate housing portion is kept open so as to expose the IC substrate to the opening portion of the case main body, when the ink cartridge is installed in the inkjet printer.

9. The ink cartridge according to claim 8, wherein the opening portion extends from the bottom portion outer lateral wall portion to a case front wall portion positioned on a front side in the installation direction into the inkjet printer.

10. The ink cartridge according to claim 1, wherein a front wall portion of the ink cartridge is provided with a window portion to expose a portion of the adapter in a state in which the adapter is housed.

11. The ink cartridge according to claim 10, wherein the window portion spans both a front surface portion and a lateral surface portion of the ink cartridge.

12. The ink cartridge according to claim 1, wherein the case main body includes, on a front wall portion thereof, an excessive insertion preventing protruding portion that protrudes in an installation direction into an inkjet printer.

13. The ink cartridge according to claim 1, wherein the lid includes, on an outer lateral surface thereof, a recessed portion on which a finger can be hooked.
